(19) United States
(12) Patent Application Publication
(10) Pub. No.: US 2022/0253810 A1
(43) Pub. Date: Aug. 11, 2022

(54) AUTONOMOUS SHARABLE PROJECT WORKSPACES

(71) Applicant: Arush Arora, Gaithersburg, MD (US)

(72) Inventor: Arush ARORA, Gaithersburg, MD (US)

(21) Appl. No.: 17/731,576

(22) Filed: Apr. 28, 2022

(51) Int. Cl. G06Q 10/10

(52) U.S. Cl. CPC G06Q 10/103

(57) ABSTRACT

This invention is a system and method to enable an efficient and distraction free project based computing environment that automatically updates itself with the needs of the person regarding the project. This is enabled by organizing the informational elements of projects (and sub-projects) automatically based on the identified needs of the project, providing relevant (and only relevant) information and notifications when the person is working on a project, providing data in a correlated manner like timeline of events to the person, reducing the reliance of the person on searching for information elements, automatically keeping the new information organized in background, and tracking metrics of time spent in the project. This invention also provides a system and method to share such workspaces in a collaborative work environment like in a school where students are working on similar projects or assignments under the guidance of the teacher, or in a corporate environment where several people are working on a project together. This is enabled by creating templates for such environments that can be shared and personalized to enable groups of people working on same or similar projects to utilize workspaces defined for the project together in a collaborative manner. Use of workspaces in this manner allows for increased productivity of the group to accomplish their projects.

### FIELD OF THE INVENTION

This invention relates to the field of computer applications particularly related to computer user interfaces and the methods provided by computer user interfaces to enable people to perform their work whether personal or professional.

### BACKGROUND

Interaction of people with computer user interface is primarily based on elements provided by the ‘Operating System’ of the computer, like files, windows, gestures, window management, etc. and elements provided by various ‘applications’, like word processors, spreadsheets, presentations, emails, calendar, messaging, and so forth that generally open one or more ‘window’ in the User Interface. The computer operating systems and applications are designed to work with together with each other using organizational elements like files, folders, bookmarks, favorites etc. as depicted in FIG. 1 which depicts a typical screen with various windows like File Explorer (100), Email application (101), Messaging (102), Web browsing (103), other applications (104), as well as placement of a Navigation Bar (105) at the bottom at that allows for opening and choosing windows and a place to show system Notifications (106). The operating systems have a concept of ‘notifications’ that notify the user about an event related to the Operating System or a particular application, like a new incoming email, a new incoming message, a new pending software update, etc. These notifications are intended to give useful and timely information to the user so that they can take some action if needed. Some computer systems might include a User Interface concept of a ‘Desktop’ in which certain application windows can be assigned, and the person can switch to one of many desktops to work on using a keyboard shortcut or gesture as depicted in FIG. 2 with choices of different desktops (200, 201, 202) and windows open in the current desktop (203, 204, 205). Such Desktops are meant to be created, arranged with layout of different application windows, and updated by the user per their needs.

Human work is not just about applications or files or folders or responding to all notifications. People work on their professional or personal Projects that utilize these elements of a computer and the best work comes from focused, distraction free and concentrated effort on a particular project for a certain length of time [4]. As part of working on a project, the person would be working on several ‘Informational Elements’ in the computer like email and messaging conversations, a set of productivity files, spreadsheets, presentations, calendar invites, browser tabs and bookmarks, collaborator contacts etc. As depicted in FIG. 3, people (304) work on a specific information element of a project (300, 301, 302) at any given time, and would switch between the elements or the projects over time. In several cases it is also important to trace the history and timeline of this project to find next steps that need to be worked on. The current computer user interfaces do not allow the person to create and autonomously maintain workspaces that have ready access to all project related informational elements, related timelines, and provide an organized view of each project. Rather on the flip side, the current computer user interface requires the user to spend time in ‘search’ in various applications for different elements that may or may not bring the right information, deal with various ‘notifications’ in the meantime about unrelated events and projects, and manually attempt to organize or group the various open applications, tabs, windows, etc. using the UI elements provided by the OS. The current method of how a person works on a project on a computer is an adaptation by the person to use the computing environment and UI for their projects, and in the meanwhile try not to be distracted—or frustrated—and it does not really work towards maximizing productivity, efficiency, and focus. The current method eventually creates a distracted and cluttered environment, as the system design is not towards holistic project-based work. Particularly in case of young students who are working on computers in school and on school projects, it is important for students to be able to work in a focused manner. In the physical workspace, the student is expected to open the textbook for the class, class notes, and other class related material (like calculator etc.) on their desk during the class. However, if the student is working on the computer either in class or in a virtual setting, during instruction time in class the workspace on the computer is up to the student to setup—and it can include any open documents, windows and browser tabs that are completely unrelated to the class. It is the same situation in case of a student doing homework at home. It is not hard to imagine the benefits if the teacher can create and publish a ‘Project Workspace’ for the classroom that may in some embodiments include, for example, lecture notes, problem set, answer sheet, reference documents or textbooks or websites, calculator application, and any relevant collaboration channels for students etc. —essentially all the material that the student should need while in class or working on an assignment of that class. Such a defined workspace if used during the class, would enable the students to focus on the material for that class, pay better attention to the instruction, and finish their assigned tasks in minimal time whether during class or while competing homework as the working environment presents the needed (and only the needed) elements to complete the task efficiently. Further, a person could switch from a project workspace to another project workspace rather than switching desktops or other user interface constructs when they switch their work to another project. As an example, consider the student moving to another class when the bell rings—and correspondingly in the computing environment, closing the project workspace for the class and switching to the project workspace of the new class that makes all the relevant information, tools, notifications etc. for that class available so that the student can immediately turn the attention and focus on the new class. In a similar manner, consider a person using a computer for professional work in a company or organization. This person has a variety of projects to finish in their daily work related to their deliverables. Each of these deliverables is one or many projects for this person, and while working on a project one should be able to focus on the project by finding all related material easily as well as not be distracted from the needs of other projects as far as possible. In a collaborative environment a group of co-workers working on a specific project can benefit from a shared project workspace that allows co-workers to use a collaborative project workspace customized for their needs. Hence the project workspaces can be used to create efficient, focused and distraction free collaborative environments for professional and personal work.

In this invention we refer to prior art “Project Workspace Prioritization” [1] that is a US patent issued in 2018 for a system and method to define a project workspace and determine relative priority of projects based on associated tasks. This patent addresses the method for a person to create and maintain a project workspace, and to be able to prioritize their work based on the priority of the project workspaces. There are several technical challenges in using this system and method: the system does not autonomously add new data to an existing project rather only adds new data when the user manually adds it to a project, and the system is defined for only one user for their individual work on different projects, but there is no method for a project workspace for group or shared collaborative use that will be typical in an organization, enterprise or a school. In this invention a system and method of creating autonomous shareable project workspaces is presented that is a technological improvement over and above the prior art.

### SUMMARY

In this invention, a system and method are developed for defining, automatically updating and sharing project workspaces that hold all of the information, data, and media relevant to particular projects that a person is working on or a group of people are collaboratively working on. This invention overcomes the shortcomings of prior art and provides additional benefits of autonomous updates to the workspaces, sharing of the workspaces, relationships between workspaces and tracking of usage metrics as the workspace is being used.

At any given time, a person will be working on several active projects, whether in professional work or personal environments. As a simple example, a person working on their home computer may have various projects—for example projects for school, passion projects for programming, home improvement, car research, book reading, or their hobby of astronomy—and respective information in mind. The computer user interfaces only provide visual layout by adjusting and organizing windows of different applications on screen, and potentially in virtual groups (desktop) that can be switched around. The computer user interfaces provide manual methods for organizing information in files, directories, browser tabs etc. In this invention a Project based user interface approach is presented that can help focus on the project work at hand, minimize distractions, keep meaningful and related data on hand, and be used in a sharable manner that allows one to share such workspaces in a collaborative manner with co-workers or collaborators. Consider a student working towards a class assignment, the invention would enable the student to create a project titled, for example, Project “Science Class Homework 5: Astronomy,” that would have a workspace that would start to show only information and notifications relevant only to this project and exclude data from other projects. While the person is working on this project, the workspace would show only documents, emails, collaborators, channels, and browser tabs etc. related to astronomy, to the extent that matches the user's specific interest in that field. Notifications would be tailored to only display content related to the current project, such as the arrival of a certain email on constellation news rather than political news or a notification on family messaging channel. This project would be related to other projects in the science class and can inherit and share data elements from them. Dynamic data elements like incoming email, collaboration messages, updated documents etc. are automatically updated and associated with the correct project workspaces. When the user decides to switch their attention and work to a different project, the project workspace would then be completely tailored toward showing documents, emails, tabs, and notifications relevant only to the new project and its context, or associated objectives. Certain applications and data relevant for all projects, such as music applications, social media, and priority contacts (family members), would be considered relevant to all projects for the user's convenience. Projects defined and used in such ways would in some embodiments have a method of sharing. In the above example the science teacher at the student's school can create a template of the “Science Class Homework 5: Astronomy” project loaded with the essential information (like assignment, textbook, notes, other resources) to share with the students, and the students can start from this template and personalize it towards their needs. The project workspaces can track metrics of how time was spent working on different projects, and in a collaborative environment metrics for different users can be aggregated and shared if so chosen by the users. Hence in this manner the science teacher can have statistics-based metrics of time spent by the students on various homeworks. This invention would enable a method of working that would increase productivity, reduce distractions as well as provide better, intuitive and sharable management of the information that a person uses and needs while working on projects on a computer. This invention provides increases in productivity in a group setting as various collaborators can use shared project workspaces to work efficiently and collaboratively as a group.

### BRIEF DESCRIPTION OF THE FIGURES

FIG. 1 shows the user interface of a computer that has various windows open for File Explorer, Emails, Messaging, Web Browsing etc. as well as a navigation bar and notifications for the user according to an embodiment of an invention.

FIG. 2 shows the multiple workspaces arranged as desktops that a user can choose to work in, and each desktop being an arrangement of multiple application windows open according to an embodiment of an invention.

FIG. 3 shows how a person thinks in projects and all associated documents, files, browsing activity, emails and messaging related to that project.

FIG. 4 shows how a person would work on a project and make a decision to work on a different project.

FIG. 5 shows how a person works in a computer UI on a project while handling notifications from the UI and while searching for relevant information to the project in the UI.

FIG. 6 shows a project workspace based computer UI for choosing a project workspace to work on according to an embodiment of an invention.

FIG. 7 shows the hierarchical relationship between various projects for a person, and association of projects with a master project.

FIG. 8 shows the workflow for starting a new project workspace in a computer UI according to an embodiment of an invention.

FIG. 9 shows the workflow for autonomously associating new data elements or identifying elements with relevant project workspaces according to an embodiment of an invention.

FIG. 10 shows a logical view of associating project workspaces, with identifying elements, data elements and with master project workspaces according to an embodiment of an invention.

FIG. 11 shows the workflow of sharing a project workspace from one user to another using a shareable template according to an embodiment of an invention.

### DETAILED DESCRIPTION

### Definitions and General Techniques

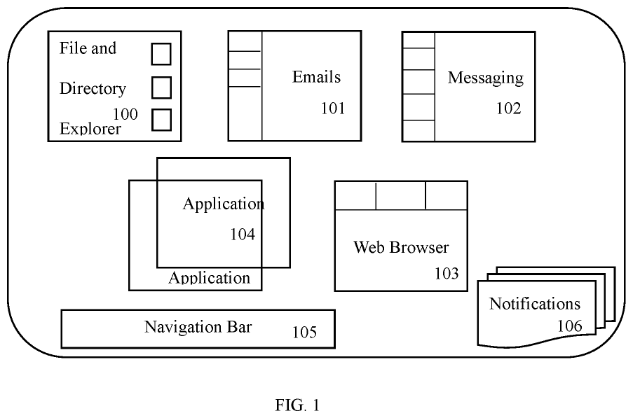

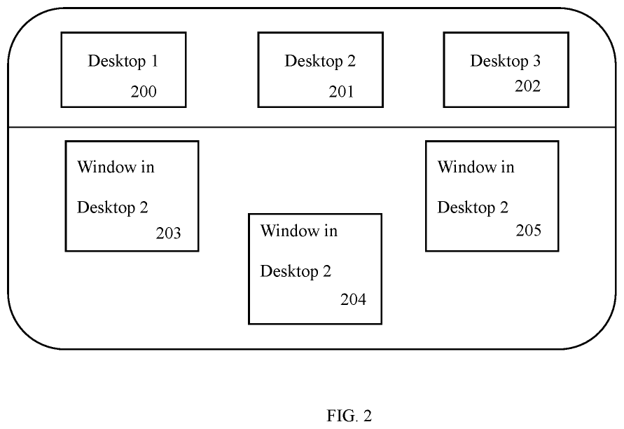

Modern computers provide a User Interface (UI) for Human Computer Interaction (HCI). The UI is composed of elements that are provided by the Operating System (OS) like files, directories, windows, icons for applications, notifications, and virtual desktops to organize windows. The computers run applications like browsers, calendar, messaging, productivity applications for documents, spreadsheets, presentations, etc. (FIG. 1). The computer UI provides elements to manage multiple application windows including organizing them in distinct workspaces that can be selected one at a time on a screen. Selecting a workspace (or a desktop) then brings the application windows assigned to that workspace in focus, as well as hides the rest of the windows that do not belong to this workspace (FIG. 2). The computer OS also provides multiple methods of managing workspaces, including gestures and keyboard shortcuts for some operations. Various events like a new email, a reminder for a meeting in calendar etc. are presented to the user as notifications in various forms like a banner in one corner of screen, a sound etc. Personal computers today are primarily based on one of the following OS families: Microsoft Windows, Apple MacOS, Google ChromeOS and various distributions of Linux like Ubuntu, RedHat etc. Any person who uses any personal computer today will be familiar with all the concepts mentioned above.

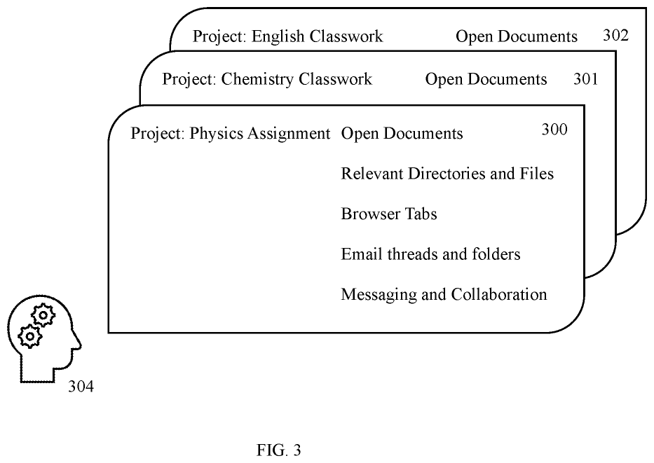

A person is using the computer to accomplish several projects (FIG. 3) in their professional or personal work. Each of these projects has unique objectives as well as information required to complete it. The needs of each project can require certain documents, email or collaboration conversations, browser windows for internet content, and applications for specific objectives like drawing or calculating or taking notes etc. As a person works on a project, their focus is the needs of the project only and having all such information and data available creates a focused environment. In this environment, if other data and information is not presented and any searches for information yield precise and relevant information, it provides the method of optimally accomplishing work on projects by immersing in distraction free ‘deep work’ for a certain duration of time on a specific project related activity. During this immersive work, one does not wish to be distracted with other projects and disturbances that demand and divide attention to another subject. If there was a distraction, and the attention switches to another matter then one can lose the focus on the project and must regain the immersive state of mind from square one. The distractions then not only create a sub optimal work environment but also acclimatize the person with a distraction-full environment which itself has a profound effect on the person—a slow decline in the ability to work in immersion and emergence of a new distracted manner of work that exhibits itself in broader behavior patterns. The need for deep focused distraction free work and creating personal environments to do so has been chronicled in various books: see [2], [3], [4]. The current user interfaces in computers do not provide such distraction free environments and are neither aware of the project that the person is working on nor its information and notification needs. For the young generation that now routinely uses computers in their school time, whether in-person instruction or virtual, this presents even more unique challenges. The younger minds distract easier and the availability of all types of content on their fingertips when working on the computer as opposed to much less when working with pen, paper, books, and calculators gives more than needed opportunities to switch to tasks other than the one at hand. Such opportunities for distractions then become a routine way of working for the young minds, as they do not have any alternative systems and methods of working offered by the computer user interface they use.

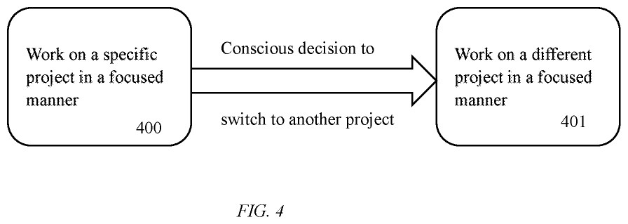

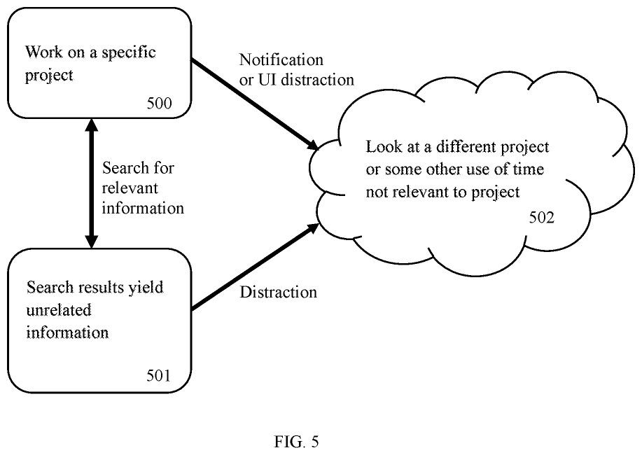

The ability to work on a specific project in a distraction free manner, given the enablement from the technology they are using, i.e., the workspaces and other UI constructs provided by modern computers, needs to be examined. The desired focused and distraction free method of how one should be working on completing projects on a computer is shown in FIG. 4 wherein a person working on a specific project (400) makes a conscious choice to switch to another project (401). While the actual manner one does the work is shown in FIG. 5 wherein the distractions and notifications can be responsible for a change in focus instead of a conscious switch from a project (500), notifications, searches, and other distractions (502) lead to a time duration where productive work for no project is accomplished (503). This is due to many reasons, to start with the computer system hardly provides the user with the construct of a project that encompasses productivity files, folders, collaborators, browsing activity, emails, messaging, meetings, notes, etc. in one construct that can visualized, manipulated, updated, and worked on as a whole. One might be able to do some makeshift effort by organizing files in a directory, emails in a folder, browsing activity in tab groups, application windows in a desktop workspace, and the like but this is simply makeshift and an effort by the person to work around the ineffectiveness of the computer UI to support the real need. Even in this makeshift method, any new file or email or browser tab must be manually kept in its desired group construct (directory, folder, tab group etc.). While working in this manner, the person might search the local (or cloud or internet) systems for different files, or emails looking for a certain artifact related with the project—however the search operations in any application are agnostic to the person's work on a project needs and return matches on any artifact where the keyword may exist, whether there is any relevance to the project. It is left to the user to sort through the noisy search results. There is a similar situation with notifications as the computer UI would show notifications for any incoming email, message, or other matters irrelevant to the project—leaving it to the person to sort through what is important in the middle of their work on the project. The view of unrelated data in applications like email, file explorer, and presentation of irrelevant results in searches and notifications create conditions for the person to be distracted with other matters, and the computer keeps continuously presenting such opportunities as the system is completely agnostic to the needs of the person to work in a state of immersion on a certain project as depicted in FIG. 5. The computer UI mechanisms not only hinder the ability to ‘deep work’ on a project, but they also actually create conditions of continuous distractions and transactions that cause the person's ability to ‘deep work’ itself decline towards a more transactional ability to work with continuous context switches. This is even more prominent in case of young students who are now spending a very substantial chunk of their time working on a computer whether it be at home or at school. Particularly in the case of a school classroom, contrast this method of working against a time when the students did not have or open their computers (or mobile phones) in school, and had an open textbook, a notebook for the subject and other relevant material like calculator etc. on their desk only.

In many environments, people work on similar or same projects and a similar examination is needed for the collaborative situation. Consider for example, in a school or college students working on a particular homework assignment of a certain course. All these students would need almost the same digital resources online—textbook chapter, assignment, calculator, lecture notes and such. Alternatively, in a corporate or organization office there could be several people involved in a project that requires viewing or editing the same documents, following conversation in same email threads and collaboration channels involving specific people, following same or similar online resources, etc. In such cases, currently there is currently no method provided by the computer UI to create and share a template for such a project workspace that defines certain files, directories or websites that are needed, certain emails labeled with a set of keywords or collaborators (or both) are needed, certain messages or collaboration channels that are relevant to this project would be very beneficial to start with. In the absence of such, each collaborator is essentially using makeshift methods described in the above paragraph to create their own version of a workspace that can significantly differ from another person's. The collaborators would highly benefit from gaining a shared workspace where the core needs and elements of the project are assembled in a common manner and individuals can customize it per their needs.

Further, most people have an expectation of time spent on a project, and one should not be spending too little or too much time with respect to the expectation. In a school context for example, an assignment might need an expected time of 30 minutes (+/−15 minutes), and if a student were to take 90 minutes, it clearly demonstrates a need for the teacher to pay individual attention to that student. Similarly, if more than half the class took more than 60 minutes, it clearly demonstrates that the expected time for the assignment needs to be reconsidered. In current computer UI, since there is no concept of a project there is also no method for the computer UI to be able to measure such time or other metrics. In this invention the method of working on a project workspace can track the time spent working on the project accurately, as well as in a collaborative setting the teachers and group leaders can also use these project templates to provide time guidelines to student (like this assignment should take 15-30 minutes) and seek metrics about how much time the students actually spent on it. If this structure was consistently used in the classroom, it can help identify students that might have spent too much time on it (and hence need help with concepts) and identify when the real average or median time may be far away from teacher's expectations. In a professional environment such time tracking can understand the time tracking metrics of the group and use those for better prioritization, planning and other project needs.

In this invention, a system and method of creating, sharing, and working on autonomous project workspaces is proposed. The ‘Project Workspace’ construct is created based on the understanding of a ‘Project’ a person is working on through its relevant documents, directories, email conversations, collaborators, browsing activity, messaging activity etc. tied together by the needs of the person to work on that project. The workspace or desktop construct of the UI is then modified to show elements pertaining to the project being worked on only, in every relevant application window (for example relevant emails in mail application, relevant files and directories in file explorer, relevant tabs in browsers, relevant chats and channels in messaging applications, etc.). The search results and notifications shown while working on a project workspace should be the ones relevant to the project. While working on any project, there would be some information elements and applications (like music players) that are common and can be configured to show on all project workspaces. Similarly, there would be notifications that are always needed (like upcoming meetings, reminders, messages from family etc.) and could be shown in any project workspace. The project workspaces would be ‘Autonomous’ in that once created by the person using some seed data for the project, they can automatically associate new data (files, emails, messages etc.) with the right project(s), constantly keep the project up-to-date, and improve associations by seeking feedback from the person regarding these autonomous associations to improve the association engine over time. The concept of ‘Project’ is generic in the sense that one project can have overlaps with other projects, as well relationships to other projects in a hierarchical manner. In the specific case of a student in a school there can be a project for a certain course in their grade, and then associated projects for each assignment that might overlap in content with each other with respect to some files and other data. The relationships between different projects will be stored in a tree like hierarchical manner, and Projects would inherit information from their parent projects. To share a project, there would be a method to create a template for the project in a manner that it can be shared with another person, and it can help kickstart a similar project for their needs. The templates would be constructed in a manner that does not expose any personal information but only provides basic layout of the information elements and UI needed to complete the project. The project workspaces can be rendered in the computer UI workspaces (or desktops) by allowing the person to choose a certain project workspace, and this choice will then filter the visible data elements, applications, search results, and notifications to be those tagged as those relevant to the project only.

The purpose behind this invention is to facilitate and enable a person to conduct deep and focused work on a certain project with availability of all relevant information and notifications only in the Computer UI. Removing the irrelevant information from field of view and removing notifications that are not relevant to the task at hand would create a less distracting environment, and hence enable the person to focus better. In this manner, this system not only assists the person to conduct focused deep work on their computer towards their projects, but this method of working over-time would increase the attention span of the person and boost overall productivity. It also allows for similar efficiencies in collaborative projects done by many involved people. It can reduce the time to start a project by starting on a shared template and collaborate better by sharing updates in an easier manner with the group.

Following are definitions of terms that are utilized in the description of this system:

Computer: In this document a computer is any computing device that a person works on by interacting with its user interface, whether a mobile device, a laptop or desktop computer, or a computing system running in cloud. The term is used to represent the hardware and the software that together provide a functional computing device.

Operating System (OS): is any Operating System of aforementioned ‘Computers’ that provides elements of interacting with and managing a computer. The OS provides the concepts of files, directories, UI, and applications. It comes bundled with some applications like calendar, email processing, browser and can install and run other Applications once installed. The OS can be any modem computer Operating System (for example Apple MacOS, Microsoft Windows, Linux distributions, Google Chrome OS) or mobile platform OS (for example iOS, iPadOS, Microsoft Windows, Android) for the purposes of this document.

User Interface (UI): is the interface for the computer provided by the Operating System using which a user (person) interacts with the computer and its various elements. The UI is offered by all modem Operating Systems (for example MacOS, Windows, Linux, Chrome OS) and is similar in all the aspects considered in this patent. Henceforth for the purposes of this document UI will refer to UI of any modem computer OS.

Application (or App): an application is a software program or set of software programs that are used for a specific purpose, run on a computer with the aid of the OS, and may in some embodiments provide a UI based interaction with the user by creating application windows and notifications. An application can be part of an OS (like calendar, email application, web browser etc.) or can be installed separately (like Microsoft Office suite of applications, collaboration apps like Slack, etc.). Applications can open different windows in the UI—for example opening Microsoft Word application would start with one window and multiple documents can be opened each in its own window. The application relies on the UI for window management and other functions like placement and size of windows in workspaces (desktops). Many applications today can have functional component(s) on the computer and data in other resources (for example in Cloud) that work together for the purposes of the application. For example, Microsoft Word with Office 365 has an application and data on a computer as well as data stored in the O365 cloud, and the two of them come together to provide the application experience to the user. Such a distributed application is considered as a singular aggregate application for the purposes of this document.

Workspace (Desktop): A workspace is a set of application windows visible in a UI at any given time. The UI of many OSes allow for creation of different workspaces (or desktops) and associating a set of application windows with a workspace. As an example—a ‘Desktop’ in MacOS is such a workspace. The UI also allows for keyboard, mouse and trackpad-based shortcuts and gestures to be able to manage, switch, manipulate and organize windows as well as workspaces themselves.

Notification: A notification is an event that happens in the OS or in an application and is in some manner conveyed to the person in the UI at the time of its occurrence. There are multiple embodiments of this, including the most popular embodiment as a banner in the UI that appears when the event happens, and disappears in some time or on user action. A notification can also come with one or multiple sound effect(s).

Data Elements: Data Elements are defined in this document as different types and pieces of information that a person utilizes to accomplish work on a computer. This would include but is not limited to: files for productivity suites like word processors, spreadsheets, presentations (Microsoft Office or Google Suite or Adobe Acrobat other application formats), email conversation threads and meeting invites, directories or folders to organize files, pictures and videos, contacts for collaborators, messages over messaging or collaboration applications (like Apple iMessage, Slack, Microsoft Teams), webpages and related organization units like bookmarks and URLs, notes that are captured by the user (in Stickies, or in applications like Evernote, Microsoft OneNote), music players (like Spotify, Apple Music) and many more.

Project: A project is an individual or collective effort planned and executed to achieve a particular aim. For the purposes of this document, consider projects as the subset for which a person works on using a computer, for example a student can work on a homework assignment for a class, or passion coding project, or work on research for college programs etc. A computer, its UI, workspaces, and data elements are all tools used by the person to conduct the work of the project, organize the information needed, and organize the data elements themselves by the needs of the project, in order to achieve the aim of the project. A project requires dedicated attention to make progress into, and it may require several blocks of time spent on it to complete. A project can have a goal of when it needs to be finished, milestones based on work or time, and projections on how much more time is needed to finish the project. While working on a project during a certain chunk of time dedicated for that project, the person would ideally dedicate their attention in that time to the needs of the project only. A project can be a collaborative enterprise between a group of people working together towards a collective aim.

Autonomous Project Workspace: A ‘Project Workspace’ is a logical and visual organization of various data elements of a project for a person, designed to organize the data and visual workspace of the computer to optimize the manner of working on a project. A project workspace would include but is not limited to: the arrangement of application windows that are part of the data elements of the project, a filtered view of data in the various application windows to only show elements that are related to the project (for example, a view to filter the email threads in email application to show the threads that are related to the project only), a filtered view of the search results in various applications to show data elements that are related to the project only, filtering notifications of various applications so that only notifications relevant to the project are shown. In addition to this the project workspace would allow for certain applications that are configured (like music players) to be part of the workspace, certain other data elements (like messaging conversations with family) to be available in the workspace, notifications for such and notifications for time sensitive system issues (like low battery) to be shown in the workspace. The workspace will have an automated mechanism to examine any new or updated data elements (emails, documents, messages, etc.) and associate them with the project if there is a match determined by algorithms and in some embodiments verified by the users. The workspace can track the various timing and data aspects of the person working on the project, like goals, milestones, and actual dedicated time. The workspace can be related to other workspaces, for example all workspaces for assignments on a certain course are related as they use similar or common data elements like the online textbook, online calculators etc. These workspaces can also be related to a master workspace created for the course itself and can inherit certain common elements from the master.

Shareable Autonomous Project Workspace: An autonomous project workspace may in some embodiments allow for sharing and collaboration between multiple collaborators in a safe and private manner while keeping track of workspaces data element revisions. For example, the teacher of a course can share the template of master workspace of the course with the students that defines common resources like online textbook, resources used like Khan Academy course, school and course specific webpages for assignment submission and grades, online scientific calculator etc. The teacher can then create an associated workspace for a particular assignment that needs specific resources (a chapter of the book, certain problem sheets, certain notes etc.)—and share it with the students for that assignment as a template of an associated workspace. The students can use these workspaces and make local modifications like adding a document that has their work and creating their own visual workspace for the windows. The teacher can also make modifications or revisions on the workspaces (like adding a video to watch) and propagate the changes to the students. In a very similar manner, in a corporate office setting, colleagues working on a particular project can use a shared project workspace to share resources of the project like documents, email threads, collaboration channels, URLs etc. A master template can be shared with everyone involved in the project, and they can make their own individualized project workspaces that can be used while working on that project.

Information Elements of a Project Workspace: Information elements are unique and identifying features of the workspace that are extracted from the data elements associated with the workspace. The features can be but are not limited to certain keywords, or sequence of keywords, names or other information about people and their association with the project (collaborator contacts), dates and times, webpage URLs, subjects of emails. These features can be manually configured or extracted algorithmically from various data elements that are associated with the project. As an example, the information elements for a certain assignment in a course would encompass at least the set of {course name, teacher name, textbook name, textbook author, URLs for internal school site of the course, name of online courses being referred to, keywords related to concepts, etc.}. Note that if this project is related to the course project, which is the master project, and the first few information elements can be inherited from that project's information elements. As an example, in a corporate environment, consider a project for attaining a certain product certification. In this case the relevant product documentation, certificate information documents and websites, documents developed for the certification effort, collaboration channel for this effort, etc. would all be information elements. The certification and compliance department that performs such certifications regularly can also develop a master template for such certifications and use that to initiate this project workspace. The master template in this case can include the core team members involved in such efforts, document repositories to such efforts, websites related to such efforts, collaboration channels, keywords related to these efforts etc. Information elements are dynamic as the person or the automation can introduce new ones and modify or delete old ones over the course of the project, and hence use of these information elements continuously update the project with the new associations.

### System and Method

The ability to create and use ‘Shareable Autonomous Project Workspaces’ comprises different functional parts of software applications that will be considered separately in detail. The creation, management, use, sharing and autonomous updates of project workspaces is brought together using the following a backend application: ‘Project Workspace Management Application (PWMA)’ that enables many of the facets below in the computer and/or in the cloud. These facets include but are not limited to:
UI for a person to create and manage a project workspace
Processing and storage needed to maintain the data needed in the computer and in some embodiments, in the cloud
UI for a person working in a project workspace
Autonomous association engine that keeps the project workspaces updated with new and updated data
Methods and UI for depicting relationships between the data elements
Methods and UI for depicting and managing relationships between projects
Creating, sharing, and managing project templates that enable collaborative environments
Method to track, analyze and show user metrics and milestones as they work on projects using the workspaces

Project Workspace Management Application (PWMA): The PWMA is a computer application created to enable the various parts of this system like creation of project workspaces, processing and storage of data needed to enable Project Workspaces, creating hooks and menus in the computer UI to assist in this process, share the project with others, and to keep the data needed for project workspaces updated automatically. This Application will be a suite of software programs that run in the computer that the person is using, and it may optionally have components that are in other computing resources for example in the cloud or in other servers for an organization (like a school or a corporation). In this document the PWMA is considered as a singular distributed application that can be run in distributed system environments that are themselves running potentially different computer OSes including in the cloud resources. The PWMA as an aggregate provides all the necessary functionality and features for enabling the shareable autonomous project workspaces. Each of these functions is discussed in more detail in the following sub sections.

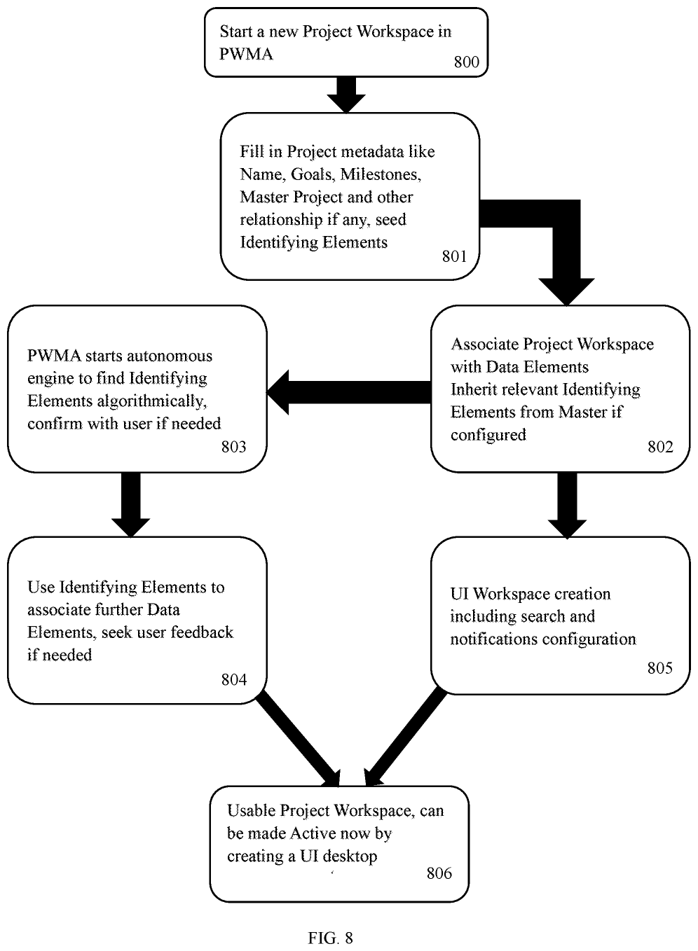

Creating and managing a project workspace: A person, who uses a computer to work on and complete a project can create a project workspace that allows this person to work on the needs of this project. The project is associated with all the ‘Data Elements’ as defined above utilized by the person for the needs of this project. FIG. 8 illustrates the flowchart for this workflow of starting a new project. The user will start a new project (800) by creating it in the PWMA and specifying certain characteristics of the project (801): project purpose, name, id, identifying features, data elements, and optionally its relationship with a master project from which the new project can inherit the identifying features (802). The identifying features of a project are multi-faceted and may include data elements, as well as information extracted from them (803). Data elements like emails, files, directories etc. and other relevant information can be associated with the new project by direct association and hence may become part of the identifying information for that project. The system uses algorithms to extract the content and context of the data elements, process the content using natural language processing, identify repeated and correlated information using statistical and machine learning algorithms. This would lead to identifying Information Elements that can be but are not limited to certain keywords, sequence of keywords, names of collaborators, dates and times of events, document types, embedded URLs, and features of other relevant types to associate with the project (804). The encompassing set of data elements and extracted features associated with the project will be referred to as ‘Identifying Information’ for that project from here on in this document. The creation of the project workspace would allow the user to configure the workspace (or desktop) elements for working on this project. This may include the following settings in some embodiments regarding how notifications and searches are handled while working in this project workspace (805): allow only notifications that are relevant to the project, allow notifications from certain contacts in addition to those in collaborators, allow certain applications (like music players) to be visible while working, etc. After the above steps are accomplished, the project workspace is now in active state and is made available for use by creating a UI workspace or desktop for this project (806).

If the new project is associated with a master project, the new project will inherit relevant identifying information from the master project if so configured. In this case, the master project is an over-arching project while the newly created project is a specific project within the scope of the master, and hence the new project is identified using all the identifying data of the master and some additional data to include specific relevant data elements.

After creating a new project workspace, the user could be optionally prompted to initiate the project by going to different applications and labeling certain data elements with the project in the different applications. The Computer UI would be modified to assist in this process by creating a menu element to tag a data element (like an email conversation, a directory, a set of files, contact of collaborators, browser tabs, etc.). The UI modification in one embodiment could be the addition of a new menu item that is visible when one clicks (or right-clicks) on the item, and this new menu item would show ‘Add to Project’ with a sub-menu showing possible projects to add to.

Once the project is created and initiated by the user, the PWMA would perform the following operations:
Store all the information about the project, including its identifying information, in a database either on board the computer or in a different system that can be in the cloud in different embodiments.
Store any new relevant relationships between data elements and identifying elements. For example, certain keywords that are extracted from a file while processing it for identifying features would be associated with the file in the database.
Periodically start a scan of the database and the data elements available in the computer and other resources to find other relevant data elements that can be associated with this project. This is done by algorithmically matching the identifying features of the data elements to the identifying elements of the project. In certain embodiments, this process may be fully automatic, and in others it might prompt the user for input on whether the association is correct or not. In other embodiments, the process can involve algorithms like Machine Learning that give a confidence score of such potential matches, and the system may take the confidence in account to make an automated match vs prompting the user for input for lower confidence cases.
Configure the computer UI to create a workspace for this project (Project Workspace) in which only the associated data elements and their associated application windows are visible. The workspace would also limit the notifications per configuration and relevance, as well as filter the search results in various applications (like file explorer, email) to only show the data elements that are associated with the project. This aspect is covered in more detail in the next section.

The PWMA application would also facilitate management of existing active projects, by providing capability that includes the following but is not limited to:
management of identifying information including allowing for corrections as needed as well as deletion of features that may result in removing association with some data elements.
association with master projects and ability to change for such
changes in other descriptive fields like name, purpose, goals, milestones etc.
suspending the project will keep the state of the project inactive and hence not actively scan new data elements for associating with the project.
reactivating a suspended project to bring it back to active state
archiving or deletion of the project and its associated data.

Processing and Storage system and method for Project Workspaces: The PWMA will include processing and storage required to maintain the data for the project workspaces. This application and all its components can be, in one embodiment, an application installed on a computer OS, or in another embodiment it can be part of the applications that come bundled with the computer OS. In some embodiments this application can be distributed with some components installed in the computer OS and other components in a cloud or private cloud environment. Many modern computer applications have a cloud component wherein files can be kept (exclusively or in addition to local computer) on cloud systems (like Microsoft OneDrive, Apple iCloud, Google Drive etc.) and emails can be stored in local applications (like Microsoft Outlook) as well as on cloud-based mail systems like Microsoft Office 365, Google Gmail etc. Therefore, data elements processed by the PWMA can be either on the computer OS or in cloud systems, or a combination of both. In a similar manner the processing and data components of the PWMA can, in different embodiments, be software applications running and storing data on the computer the person is working on, or be applications running and storing data in cloud, or be a combination of both models working together. In case there are cloud-based processing and data storage components, in some embodiments the component on the computer would provide the required functionality in case the local computer cannot reach the cloud. In all the above cases, the embodiments of PWMA would be designed to comply with requirements and regulations of data privacy and data protection for both data at rest and data in motion.

The PWMA utilizes structured storage, like a database in some embodiments, to store required information about projects. This information includes but is not limited to—association with master project, association with other projects, associated identifying elements and any associate data elements for these, association with specific data elements, project name, author and collaborators, project status, timeline, goals, milestones, settings required to display and use the project in a customizable manner in a desktop or workspace, tracking metrics for time spent on various elements of the project, etc. In some embodiments, the storage of this data can also utilize use of organizational structures provided by the computer OS like adding ‘tags’ to a file or folder in MacOS, or organizational structures provided by applications like ‘labels’ or ‘flags’ for emails and folders in Microsoft Outlook, file properties, tags and classification data in productivity files like in Microsoft Office etc. The use of such organizational structures in applications can help provide the filtered view of data in that application, for example in Microsoft Outlook the application provides a filter to view only emails with a certain tag. The PWMA would store any such application organization structures associated with the projects in its structured storage if such capability is present in the computer OS.

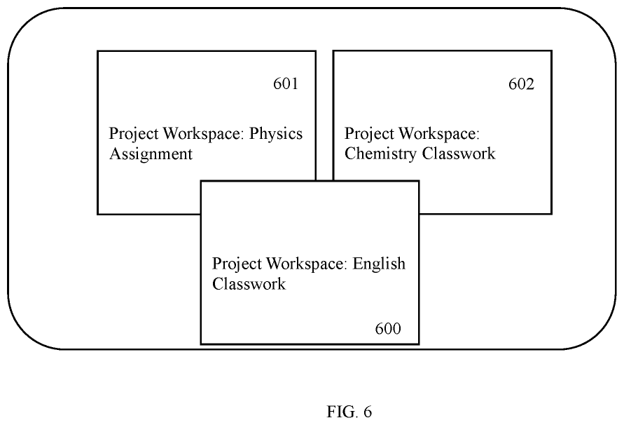

UI for Project Workspace: The UI for project workspaces has multiple elements described below and can utilize concepts and/or implementation from the computer UI that include but are not limited to workspaces or desktops, associated gestures and keyboard shortcuts for choosing one to work on, notification management etc. The PWMA would provide the user a view that shows all the active project workspaces available to work on, and a method to choose one to work on now as depicted in FIG. 6. This view in some embodiments can utilize the UI elements provided by the computer OS or in other embodiments be incorporated in the PWMA application itself. The active project workspaces that the person is actively working on the project recently, may be a subset of all the active workspaces, and there can be in some embodiments a visual or other shortcut method to switch between them. Optionally there can be a different view showing the relationships between all the project workspaces that the person has been working on actively recently and otherwise, including as an option to show inactive workspaces. When a project workspace is chosen to be worked on by the person, the workspace is now ‘Open’ and the PWMA working with the computer OS would make the visibility of applications, notifications, search results and data elements to show only those that are associated with that project workspace. In some embodiments, this can be achieved by using the computer UI and configuring or customizing it towards this objective, while in other embodiments this may be a new UI for the computer OS or an application, in yet others it could be a combination of the two methods. The workspace would make visible (whether minimized or open as a window) any data elements and the applications they are open in that are related to the project by identifying elements in the project workspace, and any search results as well as notifications related to these data elements to be visible too. Any applications that are allowed by configuration to be visible in this workspace (like music player, calculator etc.) would be visible in the workspace too. The notifications related to any visible data elements in their respective applications, or from certain configured applications or collaborators would be visible in the workspace.

The Computer UI can also reflect the project the person is working in a project workspace. In some embodiments this could be to change the color scheme, and in others it could be to add a text or banner in some part of the UI. The computer UI would allow the user to switch to a different project workspace using keyboard shortcuts, mouse controls, and trackpad gestures in a manner similar to switching between desktops or workspaces in the UI. In some embodiments this would be akin to choosing a new project workspace in the same desktop, and re-configuration of the desktop for the needs of the new project workspace while in other embodiments, there could be several open project workspaces that a person is working on, and the person can use gestures or other methods supported by the computer OS to switch between them. The UI would also provide methods to ‘Close’ a project workspace, hence saving the relevant data and state of the workspace in a manner that allows for opening the workspace from this state.

In some embodiments the workspace may be a web application viewed on a browser running on the user's computer. This would be typical in cases where the project may be based on data elements that are completely stored in cloud productivity applications (like Microsoft Office 365 or Google Suite) with no local storage on the computer. Hence the PWMA is an application that is running in the cloud with access to the productivity data in the cloud and is used by the user as a web page on a browser on their computer. In other embodiments, the data elements may be resident on the user's computer OS as well as one or more cloud productivity applications and hence the PWMA is a suite of applications running on the user's computer as well as cloud platforms, is able the access the data on both cloud platforms and user's computer and provides a UI to the user as an application on the computer OS.

Autonomous engine for Project Workspaces: With progression of time there are always new data elements created, opened, received, or shared as a person uses the computer. Some of these can be due to actions by the person (like creating a new productivity document, opening a document from email, opening a webpage, writing an email) while others can be received by the computer from external channels and people (like receiving emails, messages, notifications, updates to shared documents etc.). Many of these data elements are related to the projects currently being worked on and need to be associated with them so that they are part of the relevant project workspaces. The autonomous engine of PWMA would consider all new and incoming data elements as input to scan, analyze and associate with current active project workspaces for that user.

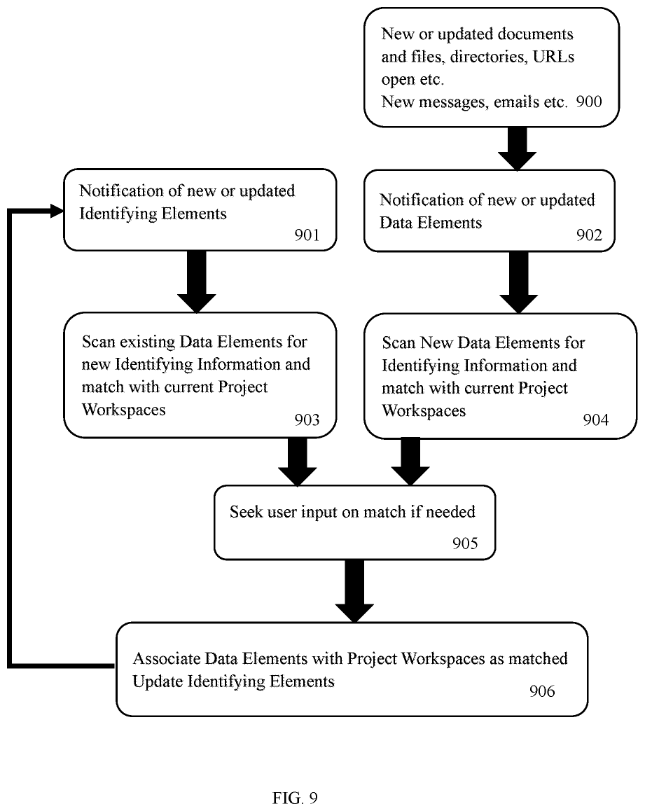

The flow of new data associations with project workspaces is described in FIG. 9. Consider new emails being received by the email application as a representative example of new data being received (900) and hence a notification for the PWMA for new data (902). The PWMA would have associated certain email conversations with certain projects at start of project and would have a set of identifying elements for each of the projects in its structured storage. The autonomous engine is a part of the PWMA that would analyze the incoming emails and make a determination on whether and which project workspaces these emails may be associated with. Consider the following two cases as part of the example: 1. Scanning of the email (904) reveals that the new email is part of a conversation that is already associated with a set of project workspaces, then the email should be associated with that set of project workspaces. 2. if the email is a new conversation thread, and analysis of the sender, receivers, keywords in the subject, keywords, URLs, other features in the content of the email shows that there is a strong match with the identifying elements of certain project workspaces, then the email should be automatically associated with those project workspaces. In case the match in case 2. above is present but is not strong enough to make an automatic association with existing project workspaces, the autonomous engine can prompt the user with choice of associating the emails with the project workspaces (905). The input from the user about a particular association provides valuable data about identifying elements and should be utilized in future associations. In another scenario, consider the case of the user starting a new productivity document. As the document is saved in a directory, it will be analyzed by the autonomous engine for potential association with existing active project workspaces based on the name and content of the file, and the directory tree it belongs to. In case the user starts the document while working in a project workspace, the document should be automatically associated with that project workspace, and also scanned for association with others. Similarly, if the document is saved in a directory that has direct association with a set of project workspaces using their identifying elements, and/or the name of the file has such associations, the document should be associated with the set of project workspaces by the autonomous engine of the PWMA. In case the associations are weak, the engine may in some embodiments seek feedback from the user for input on whether to perform such associations or not and use this user feedback for other data elements as needed.

As part of making such associations, the autonomous engine should consider the relationships between projects, and update any related project workspaces as needed. As an example, a relevant update to a master project workspace could be inherited by all the child project workspaces automatically. The autonomous engine should also analyze newly associated data elements for new and updated information elements that can be part of the identifying elements of the projects being associated with (901). In case the identifying elements of a project are updated, there might be a need to re-scan and analyze existing data elements in case there are new associations based on new information elements (903). The autonomous engine would also include logic to initiate such scanning in some embodiments that could either be automatic or periodic or on-demand or a combination of these.

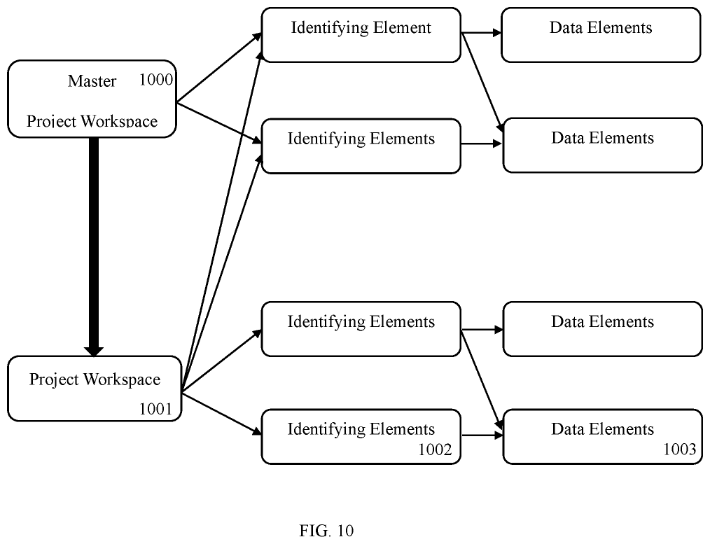

Displaying relationships between Data Elements: The data elements that are part of a project are related with a project workspace by certain information elements that associate the two. The PWMA would track the timing relationship between the data elements used in a project workspace that include but is not limited to events like creation, updates, and association of a data element, when and how much time was devoted to working on that data element, the time and reason for association of an identifying element with the project workspace and similar. The PWMA application as described above should contain all the above information as part of the structured storage data for the project workspace, identifying elements, and associated data elements. The application may in some embodiments contain a view of the project that visualizes such relationships for the user as in FIG. 10. The relationships could be visualized as a graph where the project workspaces, data elements and information elements are nodes (1000-1003), and edges show the connectivity between them. A history of the project that includes various events like creation and updates of certain documents, creation of email conversation threads, association of new documents with the project, direct associations between different data elements like attachments in an email, updates to the master project that are inherited etc. can be shown in a manner that makes it easy to track the timeline of the project's various data elements.

In some embodiments there can be a ‘Search Bar’ specifically for the project workspace, and search results would be confined to data elements associated with the project only.

Relationships between Project Workspaces: Various projects that a person is working on can be related to each other. As described before these relationships can be of following types:

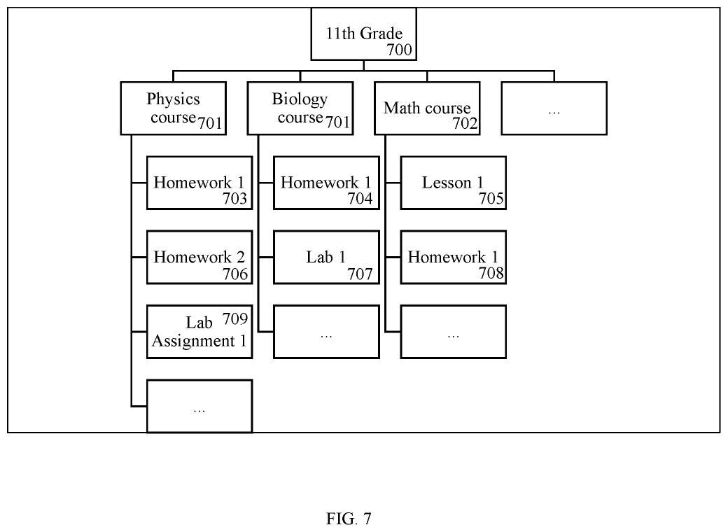

A master project that can be used to create child projects. In this case, the child project workspaces would inherit the identifying elements of the master project workspace, and potentially include more elements for better specificity of data elements. As an example, consider a master project that is a course in High School, and a child project that is a specific assignment in that course. In this case, the online ‘textbook’ document would be a data element of the master project and it should be shared with all the child project workspaces including say, a specific assignment that is a child project workspace. It is also possible to create child projects from a child project itself, that in this case would be considered the master project for this particular relationship. A simplistic view of this is shown in FIG. 7 and FIG. 10.

Two child project workspaces that have spawned from a particular master project workspace are considered to be siblings as they share many identifying elements through their relationship with the master. As an example, project workspace for all assignments and lab projects for the above-mentioned course would be siblings.

The PWMA can include a visual method to depict and show these relationships between all the project workspaces that the person has active. One method of showing this could be to show all project workspaces that emanate from a certain master project in a tree like manner (FIG. 7) and depicting all such trees of projects in the UI. In a similar manner, when one has chosen a project workspace to view its details, all related project workspaces could be shown in that view. Such a view can also be shown when the project workspace is active and chosen in the UI to work on, in its own application window that shows the details of a project workspace, and its relationships with other project workspaces.

Sharing project templates to enable collaborative environments: In a collaborative environment like a school or an organization, autonomous project workspaces not only enable distraction free focused work environments for individuals but also enable collaborative productive environments by sharing such project workspaces. Consider an assignment of a lab project for a course assigned to all students of a class and consider many thousands of such classes across the world. Each student is provided instructions that potentially include online reference material, reading material for the lab, textbook, online calculators and other experiment simulation websites, material from the teacher specific to this course, references for writing styles to write a laboratory report etc. Currently assignments for such labs are not combined with available online resources distributed to students in a structured manner—they may just be distributed in different forms like links or search terms or even left for the student to find and gather themselves. The autonomous project workspaces as described above include all this information required for a project in a structured manner and can be used to enable sharing of project information by sharing the project workspace itself. Such sharing enables all the users (students in this case) to start working on the project faster as necessary material is already accessed in the right applications in the project workspace. It allows for customization by the user (student) while working on the project to add more data elements (like a lab report, different reference material, online calculator), to re-align the workspace UI elements, and to add more identifying information as needed.

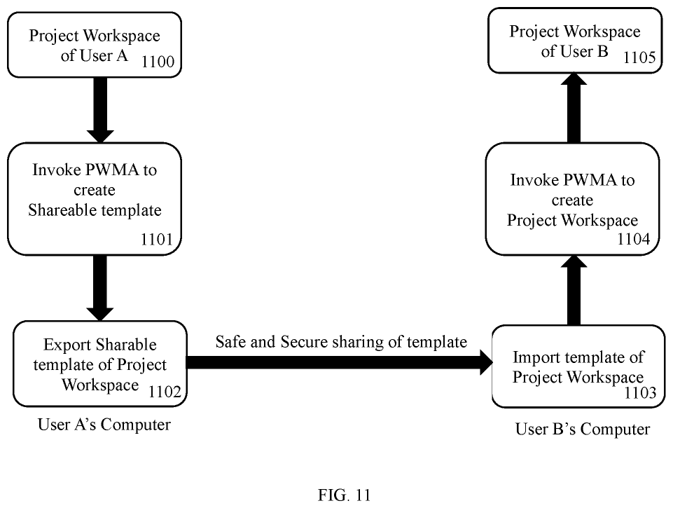

In order to create shareable autonomous project workspaces, the PWMA would enable the user to create a shareable template version of an autonomous project workspace. Sharing and accessing online resources can have multiple methods of implementation and potentially require careful consideration of permissions, private information etc. For example, URLs available on the internet are shared as URLs, however there could be documents stored in a SaaS service like Microsoft Office 365 or a particular internal website used by a school or organization to submit assignments that have other restrictions of permissions in place. Similarly, a document can be shared as a copy, or can be shared as an online resource for collaborative editing. Emails and other messaging and collaboration channels may have more restrictions on sharing due to privacy issues, and it might only be possible to share a collaborative messaging channel (like Slack or Microsoft Teams) as it has the correct access controls only defined. As seen from above considerations, the concept of sharing depends considerably on the technology used in different cases, and hence different embodiments of sharable autonomous project workspaces may differ in such manners. For the purposes of this invention, define a shareable template version of a project workspace as a version of the project workspace created by the owner of the project workspace, that contains sufficient information for the person receiving this version to start an equivalent project workspace on their own computer and online resources. Such a version should not include sender's private or access restricted information, unless explicitly chosen so by the sender. Such a shareable version may, in some embodiments, include template information that the receiver might need to fill in before starting the use of the project workspace. For the purposes of this invention, consider that a shareable version of a project workspace can be created and safely shared with other users in a manner that complies with the data sharing policies in that organization as shown in FIG. 11 (1100-1102). Such a shareable version can be considered as a template of the project workspace where the receiver of this template needs to fill in some information, create UI elements and window alignment as needed, add any new data elements if needed, and hence start using it as an autonomous project workspace on that user's computer (1103-1105).

Sharing of autonomous project workspaces can be implemented differently in different embodiments. This can include but is not limited to implementing sharing by secure availability of the template that the user can download and use. In other embodiments, all users may use a shared template and keep their local information separately in their local computer—hence the workspace is constructed from merging the information in the shared template and the local computer. There are different use cases and pros/cons of each embodiment, for example, in the second embodiment any updates to the shared template can be immediately utilized by the users.

The PWMA enables creation and use of ‘Shareable Autonomous Project Workspaces’ by
enabling users to create shareable template versions of a project workspace as specified above, and keeping the template up to date with any changes to the identifying elements in the future
distributing the shareable template to other collaborators in a safe and secure manner that is compliant with organizational policies
providing users importing a template to create their autonomous project workspace in their own computer. This step may require some configuration and addition of identifying elements to the template.
tracking any changes to the template using the autonomous engine of PWMA and associating any changes in the local information to keep the project workspace data up to date

In different embodiments, the information stored for a template can be implemented differently. In one embodiment, the template can be stored in a cloud service (public cloud SaaS or a private cloud) where all collaborating users have access. If the data elements are predominantly stored and managed in a cloud service (like Microsoft Office 365), it might be beneficial to keep the templates stored in the same service. In this case, the PWMA on the user's computer would keep and sync a copy of the template on the local computer for offline use also. The PWMA will augment the template by merging information with local information and keep it in that manner when there are changes to the template or the local information.

Tracking user metrics as they work on projects in their workspaces: As a user is working on the project using a project workspace, some embodiments can include the ability to track various metrics about time that was spent on working on the project and on various data elements associated in the project. Such time tracking is possible as working in the workspace only includes work towards the project, and all the time spent on working on the computer and different applications in the computer in the project workspace is time spent on the project. Such tracking can help develop metrics about the project and the user's focus on the project that can be measured by continuous time spent in the workspace actively working in a stretch. This data can enable the user to understand data about their own ways of working on projects, time spent on different projects, attention span for different projects and the like. Such data is not only useful for the user but in a collaborative shared setting, like that of a school (or organization) where workspaces are shared by a teacher (or manager) with the classroom (or team), and the teacher (manager) can use this data to understand the actual metrics of students (team) completing their assignments in the project. This data can be useful to calibrate assignment time expectations and be potentially used to identify group members that might need individualized attention. In these collaborative settings, such metrics and their tracking, sharing and aggregation can be used for other use cases like tracking progress goals and milestones, projecting future work and completion dates of a project.

### INCORPORATION BY REFERENCE

All references, including granted patents and patent application publications, referred herein are incorporated herein by reference in their entirety.
[1] Michael S Brown. U.S. Pat. No. 10,062,045 B2 “Project Workspace Prioritization”.
[2] Carr, N. (2020). “The Shallows: What the Internet is Doing to Our Brains.” W. W. Norton & Company.
[3] Lang, J. M. (2020). “Distracted: Why Students Can't Focus and What You Can Do About It.” Basic Books.
[4] Newport, C. (2016). “Deep Work.” Grand Central Publishing.

What is claimed is:

1. A computer application with method for creating project workspaces as referenced in [1] for making a user interface based on projects that the person is working on comprising of:
a) a computer application that allows users on all computer operating systems (Microsoft Windows, MacOS, Linux etc.) to work with project-based workspaces, created based on incorporating data elements that include but are not limited to email conversations, productivity files, collaborator contacts, files, folders, URLs in browser tabs, meeting information, collaboration chat messaging, messages to certain people or groups, and other elements that are pertinent to a project that the user is working on, that in one embodiment the application could be executing as well as storing structured data about the project workspaces on the user's computer while in others it could be executing and storing data in cloud and available on the local system using a browser, or in others it could be a combination of two with companion applications processing and storing data locally and in cloud;
b) algorithms to parse the content, context and metadata of the data elements to identify and extract certain identifying elements that are then associated with the project, these elements would include, but not limited to, keywords, expressions, contacts, dates, links, and the combined set would be used as a set of features that uniquely associate with the project and henceforth used to scan other available data and associate the project with other data elements like productivity files, folders, email conversations, bookmarks, tags, contacts etc. that are available to the user on the computer OS including the associated cloud applications;
c) storage and processing of all the relevant data about the projects including its associations with data elements, associated master project and its artifacts, identifying elements extracted from data elements, ownership and permissions, timeline of changes, and other configuration in a structured manner like a database that can be in the local computer or in the cloud or in both local computer and cloud, including configuration that may include certain applications that should always be included with the workspace (like music players) and certain important notifications (like those from certain contacts) that should always be shown in the workspace;
d) user interface modules to create project workspaces in a user interface by either modifying the GUI of the computer OS, or creating a workspace in a manner that can be displayed in a browser or in the application itself, or both, to show only the data elements associated with the project in application windows including but not limited to files, folders, email conversations, collaborators, files that are open in relevant applications for use or editing, browser tabs, collaboration channels, messaging channels, user configured applications like music players as well as limiting the notifications to be those that are relevant for the project, for example incoming email that is part of an associated email conversation data element, and relevant to the user regardless of project, for example system notifications about battery;
e) and association of a project with a master project from which it may inherit the identifying elements and data elements associated with the master project and include additional associated elements to create uniqueness and differentiation of this project from the master project.

2. The computer system of claim 1 further comprising of a method of managing workspaces based on projects comprising of:
a) a computer application for the user to manage the information stored about the project and add, modify, filter, or remove various elements, that would include but are not limited to adding new email threads, adding new keywords or removing certain keywords, adding time span information to filter certain identifying elements, adding or removing collaboration channels;
b) algorithms to reevaluate the identifying elements and associations with other data elements, that may require input from the user to confirm certain associations of the project with certain data elements, by prompting the user for confirmation and use the answer as further guidance for associations with data elements and identifying elements; and
c) user interface software modules that automatically monitor for changes to data elements and re-organize the workspace to align with new information including changes to open applications, changes to data viewable in applications and changes to which notifications should be presented on the GUI for the project workspace.

3. The computer system of claim 2 further comprising of a method of automatically processing new data elements and associate them with known projects comprising of:
a) a computer application that would be notified of any changes to data elements (new additions, updates, or removals) in the computer OS or cloud applications, that include but not limited to new files, new email conversations, new messaging conversations;
b) autonomous algorithms to scan data elements for content and context that allow association with existing projects using their identifying elements using matching algorithms, which in certain cases might require confirmation from the user to confirm match;
c) notification management for new data elements including periodically looking for new data elements in various applications like email and generating relevant notifications if so configured; and
d) algorithms for autonomous processing of data elements by adding or removing associations with various projects depending on the match with identifying elements of each project and user input as needed.

4. The computer system of claim 3 further comprising of a method to create, manage and actively use workspaces in computer user interfaces based on project data elements that create a working environment in the user interface dedicated to the needs of the project comprising of:
a) a view in the UI that only shows the data elements associated with the project, and not any other information or data elements that are not pertinent to the project;
b) a view in various applications that show documents that are part of the data elements opened in application windows, emails that are part of the data elements shown in the email application, messaging channels and conversations that are part of the data elements to be shown in the collaboration applications, files and directories that are part of the data elements to be shown in the file explorer and equivalent applications, browser tabs that have web pages of associated data elements open in browser windows, and similar for any other applications;
c) any applications (like music players) configured by the user to be open and shown in the workspace always, as well as any configured email or messaging or collaboration applications to show content from certain people or conversations or channels;
d) any notifications that correspond to relevant content that is being displayed in the workspace for that project, as an example, a notification for new email should only be shown in this workspace if it is related to the emails that are being shown in the workspace per above; and
e) a visual method for the user to be able to choose between various active workspaces, close any active workspaces, open any closed workspaces, and manage properties and information about the workspaces.

5. The computer system of claim 4 further comprising of a method to visualize the relationships between different data elements and information elements that are related to the project:
a) depicting time-based relationships of data elements, and other information elements identified by algorithms, in a visual manner for a project or group of projects, in potentially multiple different ways like a timeline view and a graph view of the data elements with relationship to identifying elements;
b) a search bar in above visualization with search results to show data elements based on whether the searched term has an association with a data element;
c) and a method to depict relationship of data elements or identifying elements with all the project workspaces it is associated to.

6. The computer system of claim 5 further comprising of a method to associate projects with each other in a hierarchical relationship and a method to visualize such in a manner that:
a) project workspaces can be associated with another as a master or as a child;
b) child project workspaces to inherit a configured subset of identifying elements from the master project workspace, and in some embodiments keep such inheritance synchronized with changes over time;
c) ability to remove master child relationship between projects and hence removal of pertinent inherited identifying elements; and
d) a visualization method to depict and display the relationships between different project workspaces in a graphical manner.

7. The computer system of claim 6 further comprising of a method to share templates of project workspaces with other users who can then use the template to create their own project workspace using:
a) definition of a shareable template of a project workspace by choosing the identifying elements that can be shared, and a method to update the template over time with any changes;
b) algorithm to create a shareable template of the project workspace and updating it over time with new and updated information;
c) method to securely share the project workspace template with other users in the organization in a safe and secure manner that is compliant with the organization policy;
d) algorithm and processing to import a template of a project workspace and adding requisite information to create a local project workspace; and
e) automatically synchronizing and merging any new information updated in the template with the local project workspace.

8. The computer system of claim 7 further comprising of a method to gather metrics about how time is spent by users while working in individual or shared project workspaces:
a) a system to track the chunks of time spent working in the project workspace, including time spent in different applications and data elements of the workspace;
b) a system to report in a variety of different time metrics including but not limited to total time spent, metrics of time spent on each application and data element in the project, number of notifications in each time chunk, number of times workspace was active and the metrics about each continuous duration in which the workspace was worked on;
c) in a shareable workspace, in some embodiments a system to report back to another user aggregate metrics of how a user spends time on different project workspaces, including average attention span of working on a project in one continuous stretch;
d) in a shareable collaborative workspace, an algorithm to aggregate metrics of all collaborators of a shared project workspace, to allow for creating objective metrics of the group based understanding of how time is spent when working on a specific project by individuals.
